(19) United States
(12) Patent Application Publication
(10) Pub. No.: US 2012/0061994 A1
(43) Pub. Date: Mar. 15, 2012

(54) PILLAR STRUCTURE FOR CONSTRUCTION MACHINE

(75) Inventors: Eiji Maeba, Hiroshima-shi (JP); Shuhei Kaiso, Hiroshima-shi (JP)

(73) Assignee: KOBELCO CONSTRUCTION MACHINERY CO., LTD., Hiroshima-shi (JP)

(21) Appl. No.: 13/216,372

(22) Filed: Aug. 24, 2011

(30) Foreign Application Priority Data
Sep. 14, 2010 (JP) 2010-205688

(51) Int. Cl. B62D 25/00

(52) U.S. Cl. 296/193.06

(57) ABSTRACT

In a structure where a floor plate (10) is mounted above a bottom plate (9) of an upper frame while being supported by a plurality of pillars, a left-rear pillar (16) required to be demounted and re-mounted, among the plurality of pillars, is provided with a spacer (35) adapted to increase a height dimension of the pillar (16), and a combination of a screw hole and a bolt (39) which serve as screw unit adapted to support a load to be applied to the spacer (35), in place of the spacer (35). Under a condition that the load is supported by the screw unit, the spacer (35) is detached to reduce the height dimension of the pillar (16). Then, under a condition that the load is supported by the remaining pillars, the left-rear pillar (16) is demounted.

### BACKGROUND OF THE INVENTION

1. Field of the Invention

The present invention relates to a construction machine such as a hydraulic shovel, and, more specifically, to a pillar mounting structure for defining a space, such as a fuel tank installation space, between a floor plate and a bottom plate of an upper frame of a swivel upper structure in a construction machine.

2. Description of the Background Art

Based on FIG. 10, the background art will be described by taking a small-size hydraulic shovel as an example. A similar structure is disclosed in JP 2008-240676A.

This hydraulic shovel comprises: a crawler-type base carrier 1; a swivel upper structure 2 mounted on the base carrier 1 rotatably about an axis vertical to the ground; and a working attachment A comprised of a boom 3, a non-illustrated arm, a non-illustrated bucket, and boom, arm and bucket cylinders (only the boom cylinder 4 is illustrated) and mounted to the swivel upper structure.

The swivel upper structure 2 has an upper frame 5 to which various devices such as an engine, a guard panel 6 covering the devices, and a cabin 8 provided with a cab seat 7, are mounted. The upper frame 5 has a bottom plate 9, and the devices are installed in a device installation space S defined between the upper frame bottom plate 9 and a floor plate 10 by a plurality of pillars, in an installation position for the cabin 8 (left-front region thereof).

The following description will be made on an assumption that a fuel tank 11 made of a synthetic resin is installed in the device installation space S which is provided with a pair of front and rear pillars each provided on right and left sides, i.e., four pillars in total (in FIG. 10, only left-front and left-rear pillars 12, 13 are illustrated). Each of the pillars has a lower end and an upper end fixedly attached, respectively, to the upper frame bottom plate 9 and the floor plate 10. The fuel tank 11 is installed removably with respect to the device installation space S in a horizontal (rightward-leftward) direction in order to perform internal washing or the like, and a left opening of the device installation space S serves as an insertion/removal port for the fuel tank.

As used in this specification, the terms “front”, “rear”, “right” and “left” mean directions as seen from an operator seated in the cab seat 7 within the cabin 8.

In the left-front and left-rear pillars 12, 13 located on the side of the insertion/removal port, the left-rear pillar 13 supporting a left-rear portion of the floor plate 10 is originally located in a tank removal/re-insertion path, so that it hinders an operation of removing and re-inserting the fuel tank 11.

Therefore, heretofore, as illustrated in FIG. 10, the left-rear pillar 13 has been mounted to be offset rearwardly with respect to the fuel tank 11 so as not to hinder the tank removal/re-insertion operation, and an upper end thereof for supporting the floor plate 10 has been formed in an inverted L shape overhanging frontwardly to a position suited to support the floor plate 10. As above, the left-rear pillar 13 is positionally constrained, and the upper end thereof has to be overhung, which brings disadvantages in terms of strength.

As a solution for this problem, it is contemplated that the left-rear pillar 13 is formed in a right cylindrical shape advantageous in terms of strength, and demountably mounted at a position suited to support a load (i.e., a position causing hindrance to the tank removal/re-insertion operation), wherein the left-rear pillar 13 is demounted during the tank removal/re-insertion operation. In this case, even if the left-rear pillar 13 is demounted, no problem will occur, because a load on the floor plate 10 can be supported by the remaining three pillars.

However, loads of the floor plate 10 and an upper structure such as the cabin 8 (hereinafter referred to collectively as “upper load”) are applied to the left-rear pillar 13. Thus, it is significantly difficult to demount the left-rear pillar 13 in a straightforward manner.

It is also contemplated to demount the pillar 13 while temporarily supporting the upper load using separate lifting unit such as a jack. However, there remains the need for improvement in that it is originally difficult to set the lifting unit at a position causing no hindrance to an operation of removing and re-inserting the fuel tank 11 and the left-rear pillar 13, and it is essential to have the lifting unit.

In view of the above circumstances, in a structure where an upper member (in the above example, the floor plate) is mounted above a lower member as a load supporting member (in the above example, the upper frame bottom plate) while being supported by a plurality of pillars, it is an object of the present invention to provide a pillar structure of a construction machine, capable of allowing at least one of the pillars as a target pillar required to be demounted and re-mounted (in the above example, the left-rear pillar) to be easily demounted and re-mounted using the target pillar itself as a tool during the demounting/re-mounting, without using separate lifting unit.

### SUMMARY OF THE INVENTION

In order to achieve the above object, the present invention provides a pillar structure of a construction machine, for supporting between a lower member supporting a load of a swivel upper structure of the construction machine, and an upper member (10) located above the lower member (9). The pillar structure comprises: a plurality of pillars (14, 15, 16, 17) disposed between the lower member (9) and the upper member (10) to support the upper member, wherein at least one of the plurality of pillars is a demountable pillar (16) adapted to be demountable with respect to the lower and upper members in a horizontal direction, and the remaining pillars are adapted, in a state after the demountable pillar is demounted, to be capable of supporting the upper member (10) with respect to the lower member (9); a spacer (35, 40) disposed on an upper or lower surface of the demountable pillar (16) and adapted to be demountable from the demountable pillar in a horizontal direction; and screw unit (39) adapted to lift up the upper member (10) by means of screw thrust so as to form a gap for allowing the spacer to be detached from the demountable pillar (16), wherein a height dimension of the demountable pillar (16) is less than a distance between the upper member and the lower member in a state after the spacer (35, 40) is detached and when a lifted state of the upper member by the screw unit is released, whereby the demountable pillar (16) becomes removable and re-insertable with respect to a space between the upper and lower members.

In the present invention having the above feature, the demountable pillar is provided with the spacer to increase a total height dimension in combination with the demountable pillar, and the screw unit to form a gap for allowing the spacer to be detached and re-attached (spacer detachment/re-attachment gap), and a gap for allowing the demountable pillar to be demounted and re-mounted (pillar demounting/re-mounting gap), wherein, in a state after the spacer is detached, the demountable pillar is demounted, and, according to the inverse process (operation), the demountable pillar is re-mounted. This makes it possible to allow the demountable pillar to be easily demounted and re-mounted with respect to a space between two members (between the upper member and the lower member) by utilizing the demountable pillar itself, without using separate lifting unit such as a jack.

Thus, positional flexibility for arranging the demountable pillar is increased, so that the demountable pillar can be installed at a position suited to support an upper load and in an advantageous state in terms of strength.

In addition, it is only necessary to add the spacer and the screw unit to the demountable pillar, and the spacer can also serve as a height adjusting shim, so that it becomes possible to keep cost low.

### BRIEF DESCRIPTION OF DRAWINGS

FIG. 1 is a schematic top plan view of an upper frame illustrating a first embodiment of the present invention.

FIG. 2 is a side view of the upper frame.

FIG. 3 is a perspective view of the upper frame.

FIG. 4 is an enlarged view of the encircled area in FIG. 3.

FIG. 5 is an exploded perspective view further enlargedly illustrating a left-rear pillar as a demountable pillar.

FIG. 6 is a partially sectional side view illustrating a mounted state of the demountable pillar.

FIGS. 7A to 7H illustrate a process of demounting the demountable pillar.

FIG. 8 is a view illustrating a second embodiment of the present invention, which corresponds to FIG. 4.

FIGS. 9A and 9B illustrate, respectively, a mounted state of a demountable pillar, and a state during a course of demounting the demountable pillar, in the second embodiment.

FIG. 10 is a partially cut-away side view of a small-size hydraulic shovel to which the present invention is applicable.

### DETAILED DESCRIPTION OF THE INVENTION

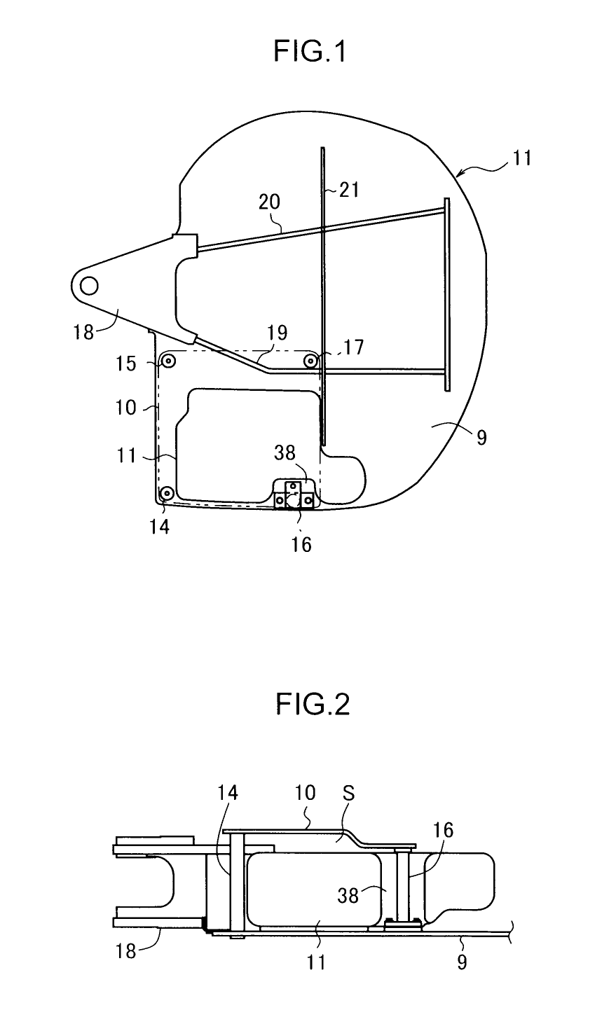

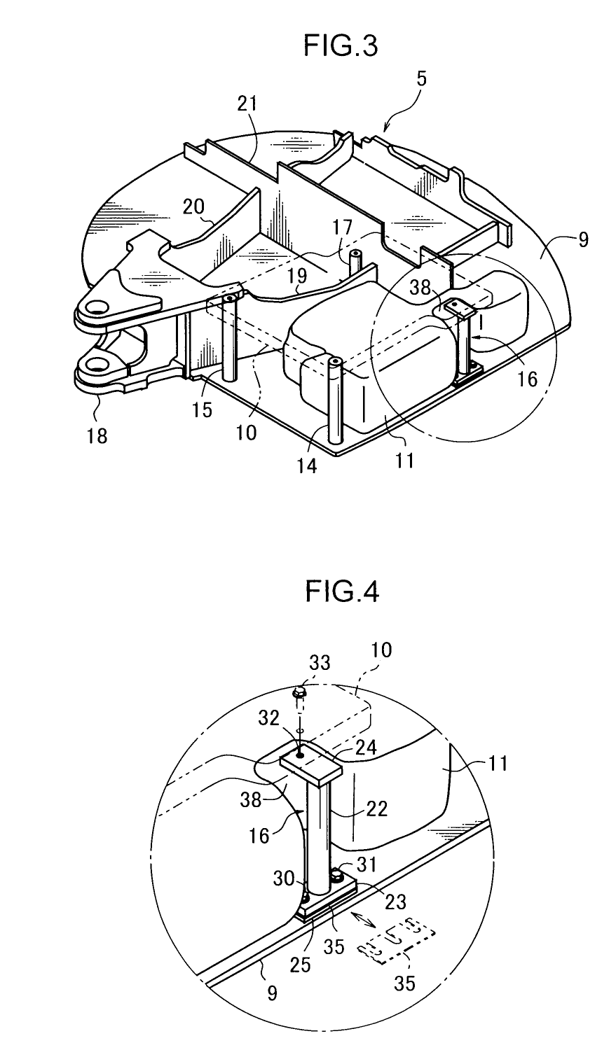

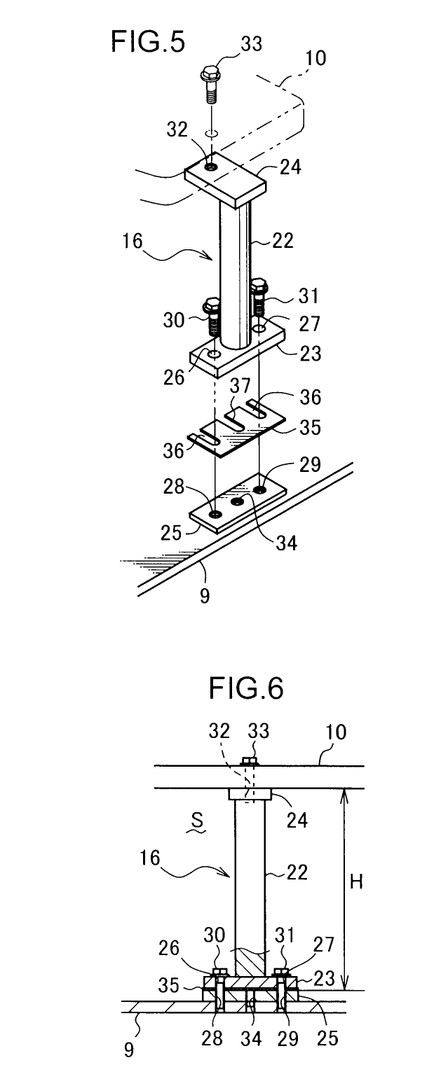

The following embodiments will be described by taking a small-size hydraulic shovel as an example, as in the Description of Background Art, and on an assumption that a floor plate 10 as an upper member is supported above a bottom plate 9 of an upper frame 5 as a lower member, by a pair of front and rear pillars each provided on right and left sides, i.e., four pillars 14, 15, 16, 17 in total (right pillars 15, 17 are illustrated in FIGS. 1 and 3), and a fuel tank 11 made of a synthetic resin to serve as a device is installed in a device installation space S defined between the upper and lower frames (the reference code S is assigned only in FIGS. 2 and 6).

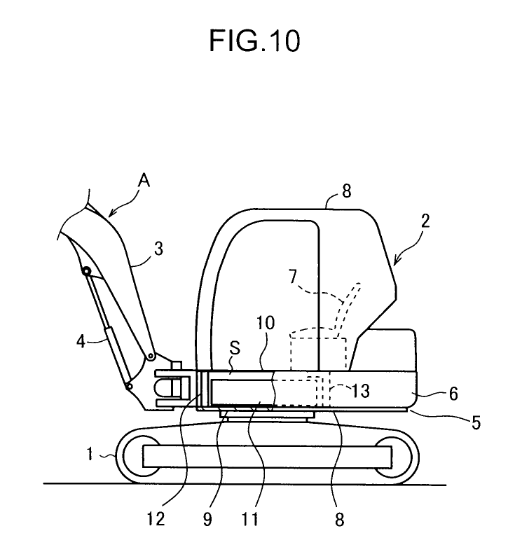

In the embodiments of the present invention, the following points (i) to (iii) are the same as those in the conventional structure illustrated in FIG. 10.
(i) Various devices such as an engine, a guard panel covering the devices, and a cabin provided with a cab seat (all of which are not illustrated), are mounted to the upper frame 5 to form a swivel upper structure.
(ii) The pillars 14 to 17 are mounted on a left-front region of the upper frame bottom plate 9.
(iii) The fuel tank 11 is externally installed in a removable manner in a horizontal (rightward-leftward) direction using a left opening of the device installation space S as an insertion/removal port.

As illustrated in FIGS. 1 to 4, the upper frame bottom plate 9 has an attachment mounting bracket 18 provided at a front end thereof; two vertical plates 19, 20 provided on right and left sides in an intermediate region thereof in a rightward-leftward direction to extend in a frontward-rearward direction; and a partition wall 21 provided in an intermediate region thereof in the frontward-rearward direction to extend in the rightward-leftward direction while intersecting with the vertical plates 19, 20. Each of the vertical plates 19, 20 and the partition wall 21 is provided to stand vertically from the bottom plate 9, and the engine and devices associated therewith are installed in a rear region of the upper frame partitioned by the partition wall 21.

### First Embodiment (See FIGS. 1 to 7)

The fuel tank 11 is installed in the device installation space S in such a manner that most thereof is received in a left-front region of the upper frame compartmented by the left vertical plate 19 and the partition wall 21, and only a rear end thereof is located rearward of the partition wall 21.

The fuel tank 11 is fixed within the space S by a tank fixing member, and an oil filler pipe having a filler opening at a distal end thereof is attached to an upper surface of a rear end of the fuel tank. These components are not illustrated, because they are not directly relevant to the present invention.

In the left-front and left-rear pillars 14, 16 installed on the side of the insertion/removal port for the fuel tank 11, the left-rear pillar 16 supporting a left-rear portion of the floor plate 10 is located in a tank removal/re-insertion path, so that it hinders an operation of removing and re-inserting the fuel tank 11. Therefore, the left-rear pillar 16 is formed as a demountable pillar, and demountably mounted between the floor plate 10 and the upper frame 9. The demountable pillar will be specifically described below.

As specifically illustrated in FIGS. 4 to 6, the left-rear pillar 16 comprises: a column-shaped pillar body 22; a rectangular plate-shaped base 23 elongated in the frontward-rearward direction and attached to a lower end of the pillar body 22 in a horizontal posture; and a rectangular plate-shaped floor-plate receiving portion 24 elongated in the rightward-leftward direction and attached to an upper end of the pillar body 22 in a horizontal posture. The base 23 and the floor-plate receiving portion 24 are demountably mounted to the upper plate bottom plate 9 and the floor plate 10, respectively.

More specifically, as base mounting unit, two bolt insertion holes 26, 27 are provided in the base 23 on both sides of the pillar body 22 in the frontward-rearward direction, and two screw holes 28, 29 are provided in the upper frame bottom plate 9 and a washer plate 25 fixedly attached onto an upper surface of the bottom plate 9. Two lower mounting bolts 30, 31 are screwed, respectively, in the screw holes 28, 29 through the bolt insertion holes 26, 27, so that the base 23 is mounted to the upper frame bottom plate 9.

On the other hand, as floor-plate receiving portion mounting unit, a screw hole 32 is provided in the floor-plate receiving portion 24. An upper mounting bolt 33 (see FIGS. 4 to 7) is screwed in the screw hole 32 from thereabove through the floor plate 10, so that the floor-plate receiving portion is mounted to the floor plate 10.

Further, a lifting screw hole 34 (see FIGS. 5 and 6) are provided in a central portion of the washer plate 25 to penetrate through the washer plate 25 and the upper frame bottom plate 9, and an aftermentioned lifting bolt is adapted to be screwed in the screw hole 34 from below the bottom plate. The lifting screw hole 34 and the aftermentioned lifting bolt or the like make up screw unit.

In this structure, a spacer 35 additionally serving as a height adjustment shim is inserted between the base 23 and the washer plate 25

The spacer 35 has two clearance grooves 36, 36 each provided on a respective one of front and rear sides thereof to have a clearance with respect to a corresponding one of the lower mounting bolts 30, 31, and a clearance groove 37 provided in a central portion thereof to have a clearance with respect to the lifting bolt. Each of the clearance grooves is formed as a cutout extending in the rightward-leftward direction to have an open right end. The clearance grooves 36, 26, 37 allow the spacer 35 to be detached leftwardly and horizontally and then re-inserted, under a no-load condition.

The left-rear pillar 16 is set such that a total dimension H (see FIG. 6) including the spacer 35 becomes equal to a distance between the floor plate 10 and an upper surface of the washer plate 25 on the upper frame bottom plate 9.

Thus, in a state after the spacer 35 is detached, a height dimension of the left-rear pillar 16 itself becomes less than the above distance (distance between the washer plate 25 and the floor plate 10), so that, in this state and under a condition that the upper load is released, the pillar 16 becomes removable and re-insertable with respect to a space between the upper frame bottom plate 9 and the floor plate 10 (washer plate 25) in the horizontal direction.

Further, the fuel tank 11 is formed with a concave groove 38 (see FIGS. 1 to 4) having a clearance with respect to the left-rear pillar 16 and extending in an upward-downward direction, in a region of a left surface thereof facing the pillar 16.

This makes it possible to maximally expand a lateral surface of the fuel tank outwardly so as to increase a capacity of the fuel tank. In addition, the concave groove 38 can serve as a rib to bring out a reinforcing effect so as to increase strength of the lateral surface of the fuel tank.

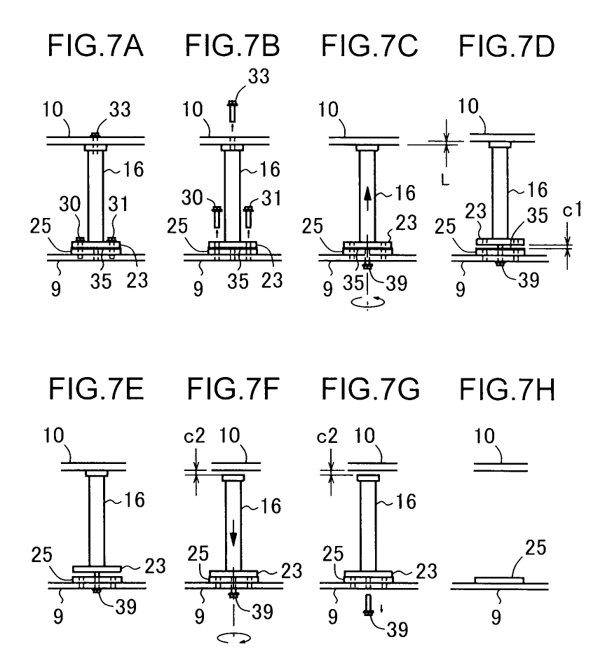

With reference to FIG. 7A to 7H, a process (operation) of demounting the left-rear pillar 16 will be described below. For avoiding complexity in illustration, only minimum reference numerals or codes are assigned in FIGS. 7A to 7H, and other figures will be referred to according to need.

FIG. 7A illustrates a mounted state of the left-rear pillar 16. In this state, the upper load is supported by the upper frame bottom plate 9 through the left-rear pillar 16 and the remaining pillars 14, 15, 17.

Then, as illustrated in FIG. 7B, the upper mounting bolt 33 and the lower mounting bolts 30, 31 are detached. In this state, the upper load is still being applied to the pillar 16.

Then, as illustrated in FIG. 7C, a lifting bolt 39 (one of the detached mounting bolts 30, 31, 33 may be diverted thereto, or a dedicated bolt may be used) is screwed in (screwed forwardly) from below the bottom plate, and further screwed in while keeping a distal end of the lifting bolt 39 in contact with a lower surface of the base 23. In this manner, the pillar 16 is lifted up together with the floor plate 10 while leaving the spacer 35 in its initial position, to establish the state illustrated in FIG. 7D. L in FIG. 7D indicated a lift amount of the upper member (floor plate 9) by the lifting bolt 39 during the above operation.

In order to facilitate the screw-in operation using the lifting bolt 39, a lifting bolt with a handle may be used.

In the state illustrated in FIG. 7D, each of the floor plate 9 and the pillar 16 is lifted up by the dimension L, so that a spacer detachment/re-attachment gap c1 is formed between the base 23 and the spacer 35, and the upper load is supported by the lifting bolt 39 in place of the spacer 35. This means that the spacer 35 is placed in a free state without receiving any load from thereabove.

Thus, as illustrated in FIG. 7E, the spacer 35 is extracted leftwardly (as seen from an operator seated in the cab seat) and horizontally, and then the lifting bolt 39 is loosened (screwed backwardly) and detached as illustrated in FIGS. 7F and 7G.

Through this operation, each of the left-rear pillar 16 and the floor plate 10 is lowered, and, then after the upper load including the floor plate 10 is supported by the remaining three pillars 14, 15, 17, only the pillar 16 is continuously lowered (the lower surface of the base 23 of the pillar 16 comes into contact with the upper surface of the washer plate 25 without interposing the spacer 35 therebetween).

In the state illustrated in FIG. 7G, a gap c2 equivalent to a thickness of the spacer 35 is formed between the floor plate 10 and the upper end of the left-rear pillar 16, so that the pillar 16 is placed in a no-load state. Thus, as illustrated in FIG. 7H, the pillar 16 can be demounted toward the insertion/removal port (leftwardly as seen from an operator seated in the cab seat).

In this state, the insertion/removal port is fully opened, so that the fuel tank 11 can be removed leftwardly to perform maintenance such as cleaning.

Further, after the maintenance, the fuel tank 11 is re-installed. Then, the left-rear pillar 16 can be re-mounted in its original position according to a process (operation) which is the inverse of that in FIGS. 7A to 7H.

As above, in this pillar structure, the left-rear pillar 16 as the demountable pillar can be easily demounted and re-mounted with respect to a space between the upper frame bottom plate 9 and the floor plate 10 by an operation for the pillar 16 itself (the lifting and lowering operation using the lifting bolt, and the spacer detachment/re-attachment operation) without using separate lifting unit such as a jack.

Thus, positional flexibility for arranging the left-rear pillar 16 is increased, so that the pillar 16 can be installed at a position suited to support the upper load and in an advantageous state in terms of strength, without a need for disadvantageous fabrication in terms of strength, such as a need for overhang as described in the Description of Background Art with reference to FIG. 10.

In this case, it is only necessary to add the spacer 35 and the screw unit (the screw hole 34 and the lifting bolt 39) to the pillar 16. In addition, the spacer 35 can also serve as a height adjusting shim, and the lifting bolt 39 can be obtained, for example, by diverting one of the mounting bolts 39, 31, 33 for the pillar 16, so that it becomes possible to keep cost low.

Further, the spacer 35 is provided with the clearance groove 37 having a clearance with respect to the lifting bolt 39 (a groove having one end in a closed state, and a width greater than a diameter of the bolt 39), so that the spacer 35 can be detached and re-attached in the horizontal direction while maintaining the screwed-in state of the lifting bolt 39. Therefore, as compared to cases where the spacer 35 is divided to avoid interference with the lifting bolt 39, the detachment/re-attachment operation for the spacer 35 becomes easier.

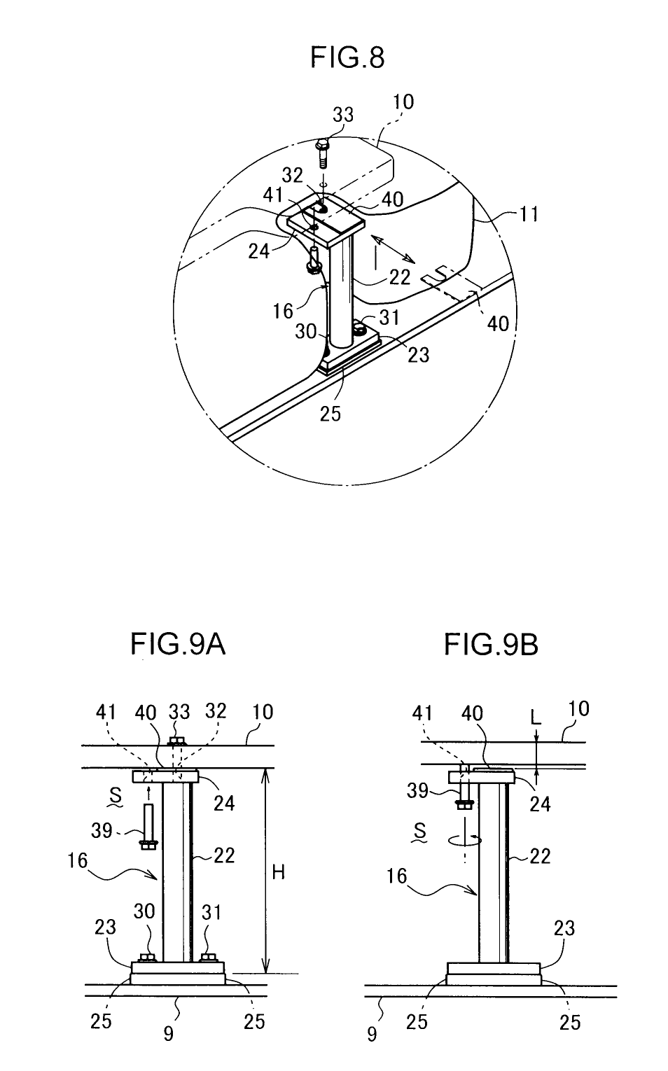

### Second Embodiment (See FIGS. 8, 9A and 9B)

A second embodiment will be described below with a focus on a difference from the first embodiment.

In the second embodiment, a spacer 40 is adapted to be inserted between the floor plate 10 and a floor-plate receiving portion 24 of a left-rear pillar 16, in a demountable manner.

The floor-plate receiving portion 24 is formed in a rectangular plate shape protruding rightwardly and frontwardly from a pillar body 22, and provided with a screw hole 32 for an upper mounting bolt 33, and a screw hole 41 for a lifting bolt 39, respectively, in a rightwardly-protruding region and a frontwardly-protruding region thereof.

In the illustrated embodiment, the spacer 40 is formed in a horseshoe-like shape (U shape) provided with only a clearance groove having a clearance with respect to the upper mounting bolt 33. Alternatively, the spacer 40 may be formed in a shape having a large width and additionally provided with a clearance groove having a clearance with respect to the lifting bolt 39.

FIG. 9A illustrates a mounted state of the left-rear pillar 16. In an operation of demounting the pillar 16, the lower and upper mounting bolts 30, 31, 33 are detached, and the lifting bolt 39 is screwed in the lifting-bolt screw hole 41 from therebelow to lift up the floor plate as illustrated in FIG. 9B (L indicates a lift amount). In a state after the floor plate 10 is lifted in the above manner, the spacer 40 is extracted. Then, the lifting bolt 39 is loosened (screwed backwardly) to form a gap c2 equivalent to a thickness of the spacer 40, and the left-rear pillar 16 is demounted.

The pillar 16 is re-mounted according to the inverse process (operation). Fundamentally, the second embodiment can obtain the same effects as those in the first embodiment.

Although the above embodiments have been described based on an example where the fuel tank 11 is installed between the upper frame bottom plate 9 and the floor plate 10, the present invention may also be implemented in cases where a battery or other device is installed therebetween.

Further, the present invention is not limited to a mounting structure of a pillar provided between the upper frame bottom plate 9 and the floor plate 10, but may be widely used as a pillar structure in which an upper structure is supported above a lower member by a plurality of pillars, wherein it is necessary to appropriately demount at least one of the pillars.

It is understood that the present invention may be applied to any type of construction machine other than a hydraulic shovel.

As described above, the present invention provides a pillar structure of a construction machine, for supporting between a lower member supporting a load of a swivel upper structure of the construction machine, and an upper member (10) located above the lower member (9). The pillar structure comprises: a plurality of pillars (14, 15, 16, 17) disposed between the lower member (9) and the upper member (10) to support the upper member, wherein at least one of the plurality of pillars is a demountable pillar (16) adapted to be demountable with respect to the lower and upper members in a horizontal direction, and the remaining pillars are adapted, in a state after the demountable pillar is demounted, to be capable of supporting the upper member (10) with respect to the lower member (9); a spacer (35, 40) disposed on an upper or lower surface of the demountable pillar (16) and adapted to be detachable from the demountable pillar in the horizontal direction; and screw unit (39) adapted to lift up the upper member (10) by means of screw thrust so as to form a gap for allowing the spacer to be detached from the demountable pillar (16), wherein a height dimension of the demountable pillar (16) is less than a distance between the upper member and the lower member in a state after the spacer (35, 40) is detached and when a lifted state of the upper member by the screw unit is released, whereby the demountable pillar (16) becomes removable and re-insertable with respect to a space between the upper and lower members.

In the present invention having the above feature, the demountable pillar is provided with the spacer adapted to increase a total height dimension in combination with the demountable pillar, and the screw unit adapted to form a spacer detachment/re-attachment gap and a pillar demounting/re-mounting gap, wherein, in a state after the spacer is detached, the demountable pillar is demounted, and, according to the inverse process (operation), the demountable pillar is re-mounted. This makes it possible to allow the demountable pillar to be easily demounted and re-mounted with respect to a space between two members (between the upper member and the lower member) by utilizing the demountable pillar itself, without using separate lifting unit such as a jack.

Thus, positional flexibility for arranging the demountable pillar is increased, so that the demountable pillar can be installed at a position suited to support an upper load and in an advantageous state in terms of strength.

In addition, it is only necessary to add the spacer and the screw unit to the demountable pillar, and the spacer can also serve as a height adjusting shim, so that it becomes possible to keep cost low.

In the pillar structure of the present invention, the lower member may include a bottom plate of an upper frame of the swivel upper structure, and the upper member may include a floor plate on which a cab seat is installed, wherein an installation space is defined between the bottom plate and the floor plate to allow a device including a fuel tank to be externally installed therein in a removable manner in the horizontal direction, and wherein the plurality of pillars are provided between the bottom plate and the floor plate, and the demountable pillar (16) is at least one of the plurality of pillars which is adapted to be demounted so as to allow the removal of the device.

According to this feature, in the structure where the plurality of pillars are provided in the device installation space defined between the upper frame bottom plate (lower member) and the floor plate (upper member), at least one of the pillars which hinders the removal of device (such as a fuel tank) is configured as the demountable pillar, so that the demountable pillar can be installed at a position suited to support the floor plate while allowing the removal of the device, without a need for disadvantageous design in terms of strength, such as a need for overhanging an upper end of the pillar.

Preferably, the fuel tank (11) has a lateral surface, wherein a region of the lateral surface facing the demountable pillar is formed as a concave groove provided to extend in an upward-downward direction at a position corresponding to the demountable pillar.

According to this feature, the lateral surface of the fuel tank as the device has a region facing the demountable pillar, and the concave groove having a clearance with respect to the demountable pillar is provided in the region to extend in an upward-downward direction. This makes it possible to maximally expand the lateral surface of the fuel tank outwardly so as to increase a capacity of the fuel tank. In addition, the concave groove can serve as a rib to bring out a reinforcing effect so as to increase strength of the lateral surface of the fuel tank.

Preferably, in the pillar structure of the present invention, the demountable pillar (16) has a base (23) at a lower end thereof, wherein: the spacer (35) is inserted between the base and the lower member (9); and the screw unit comprises a screw hole (34) formed in the lower member (9), and a bolt (39) adapted to be screwed into the screw hole in such a manner that a distal end thereof is brought into contact with a lower surface of the base, and wherein the screw unit is adapted to lift up the demountable pillar (16) and the upper member (10) together.

According to this feature, the base at the lower end of the demountable pillar can be lifted by the distal end (upper end) of the bolt only through the operation of screwing the bolt into the screw hole formed in the lower member, so that a gap required to allow the spacer to be extracted can be easily formed between an upper surface of the spacer and the lower surface of the base of the demountable pillar.

Alternatively, the demountable pillar (16) may have an upper-member receiving portion (24) at an upper end thereof, wherein: the spacer (40) is inserted between the upper-member receiving portion and the upper member; and the screw unit comprises a screw hole (41) formed in the upper-member receiving portion (24), and a bolt (39) adapted to be screwed into the screw hole in such a manner that a distal end thereof is brought into contact with the upper member, and wherein the screw unit is adapted to lift up the upper member (10).

According to this feature, the upper member can be lifted by the distal end (upper end) of the bolt only through the operation of screwing the bolt into the screw hole formed in the upper-member receiving portion of the den¥mountable pillar, so that a gap required to allow the spacer to be extracted can be easily formed between an upper surface of the spacer and a lower surface of the upper member.

Preferably, the spacer is formed with a clearance groove (36) having a clearance with respect to the bolt to allow the spacer to be detached under a condition that the bolt is screwed in the screw hole.

According to this feature, the spacer is formed with the clearance groove (with a width greater than a diameter of the bolt) having one open end, so that the spacer can be easily detached from the bolt in the horizontal direction only through the operation of lifting the upper member by a given amount, using the bolt constituting the screw unit.

This application is based on Japanese Patent Application Serial No. 2010-205688, filed in Japan Patent Office on Sep. 14, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A pillar structure of a construction machine, for supporting between a lower member supporting a load of a swivel upper structure of the construction machine, and an upper member located above the lower member, comprising:
a plurality of pillars disposed between the lower member and the upper member to support the upper member, wherein at least one of the plurality of pillars is a demountable pillar adapted to be demountable with respect to the lower and upper members in a horizontal direction, and the remaining pillars are adapted, in a state after the demountable pillar is demounted, to be capable of supporting the upper member with respect to the lower member;
a spacer disposed on an upper or lower surface of the demountable pillar and adapted to be detachable from the demountable pillar in the horizontal direction; and
screw unit adapted to lift up the upper member by means of screw thrust so as to form a gap for allowing the spacer to be detached from the demountable pillar,
wherein a height dimension of the demountable pillar is less than a distance between the upper member and the lower member in a state after the spacer is detached and when a lifted state of the upper member by the screw unit is released, whereby the demountable pillar becomes removable and re-insertable with respect to a space between the upper and lower members.

2. The pillar structure as defined in claim 1, wherein the lower member includes a bottom plate of an upper frame of the swivel upper structure, and the upper member includes a floor plate on which a cab seat is installed, and wherein an installation space is defined between the bottom plate and the floor plate to allow a device including a fuel tank to be externally installed therein in a removable manner in the horizontal direction, and wherein the plurality of pillars are provided between the bottom plate and the floor plate, and the demountable pillar is at least one of the plurality of pillars which is adapted to be demounted so as to allow the removal of the device.

3. The pillar structure as defined in claim 2, wherein the fuel tank has a lateral surface, and wherein a region of the lateral surface facing the demountable pillar is formed as a concave groove provided to extend in an upward-downward direction at a position corresponding to the demountable pillar.

4. The pillar structure as defined in claim 1, wherein the demountable pillar has a base at a lower end thereof, and the spacer is inserted between the base and the lower member; and the screw unit comprises a screw hole formed in the lower member, and a bolt adapted to be screwed into the screw hole in such a manner that a distal end thereof is brought into contact with a lower surface of the base, the screw unit being adapted to lift up the demountable pillar and the upper member together.

5. The pillar structure as defined in claim 1, wherein the demountable pillar has an upper-member receiving portion at an upper end thereof, and wherein: the spacer is inserted between the upper-member receiving portion and the upper member; and the screw unit comprises a screw hole formed in the upper-member receiving portion, and a bolt adapted to be screwed into the screw hole in such a manner that a distal end thereof is brought into contact with the upper member, the screw unit being adapted to lift up the upper member.

6. The pillar structure as defined in claim 4, wherein the spacer is formed with a clearance groove having a clearance with respect to the bolt to allow the spacer to be detached under a condition that the bolt is screwed in the screw hole.

7. The pillar structure as defined in claim 5, wherein the spacer is formed with a clearance groove having a clearance with respect to the bolt to allow the spacer to be detached under a condition that the bolt is screwed in the screw hole.
